(19) United States
(12) Patent Application Publication
(10) Pub. No.: US 2005/0147351 A1
(43) Pub. Date: Jul. 7, 2005

(54) Optical modulator

(75) Inventors: Robert Ian Johnstone, Towcester (GB); Royston Powell, Hartwell (GB); Robert Griffin, Towcester (GB); Robert Graham Walker, Northampton (GB); Brian Jeffrey Buck, Weedon (GB)

Correspondence Address: LAHIVE & COCKFIELD, LLP., 28 STATE STREET, BOSTON, MA, 02109, US

(73) Assignee: BOOKHAM TECHNOLOGY, PLC, Towcester (GB)

(21) Appl. No.: 11/005,696

(22) Filed: Dec. 6, 2004

(30) Foreign Application Priority Data
Dec. 6, 2003 (GB) 0328328.0

(51) Int. Cl. G02F 1/035

(52) U.S. Cl. 385/40; 385/3

(57) ABSTRACT

An optical modulator comprises first and second optical waveguides having first and second electrodes respectively associated therewith, and an electrically conductive region associated with both waveguides. The electrodes have inputs for an electrical signal at input ends thereof, and outputs for the electrical signal at opposite output ends thereof. The conductive region is electrically connected to the output ends of the first and second electrodes such that an electric field created by the electrical signal between the first electrode and the conductive region is substantially equal in magnitude to an electric field created by the electrical signal between the second electrode and the conductive region. The balancing of the electric fields experienced by the waveguides enables the modulation of light in the two waveguides to be balanced. The modulator may be a Mach-Zehnder modulator, and the balanced modulation may result in amplitude modulation of the optical output of the modulator, generally without phase modulation.

The present invention relates to optical modulators, and especially to optical modulators comprising Mach-Zehnder interferometers.

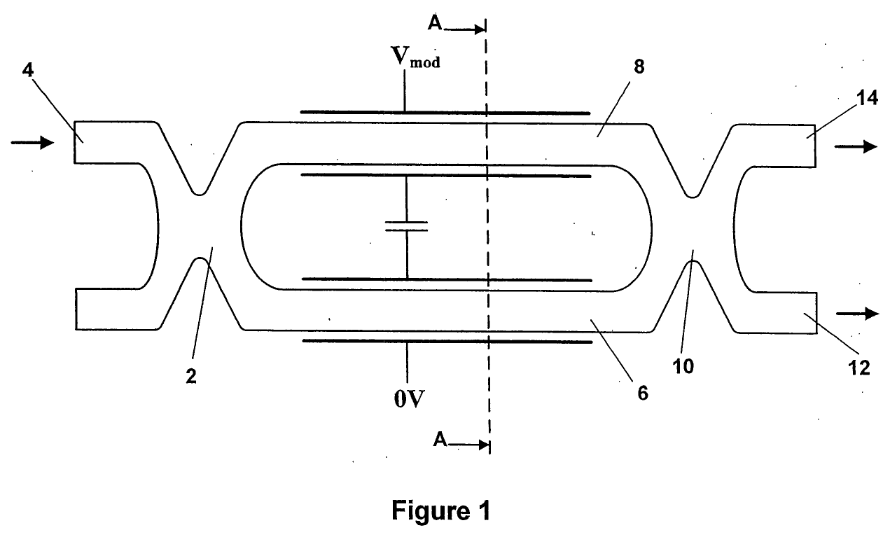

Optical modulators based upon Mach-Zehnder interferometers have been known and used for many years. Such modulators are fabricated from any of a variety of materials, including lithium niobate, group III-V semiconductors, and silicon, for example, and have any of a variety of configurations. One such configuration is exemplified by a class of modulators fabricated in III-V semiconductor materials, for example GaAs. International patent application WO 01/77741 (now assigned to Bookham Technology plc) discloses the basic structure of some known GaAs optical modulators in FIGS. 1 to 4 of that document.

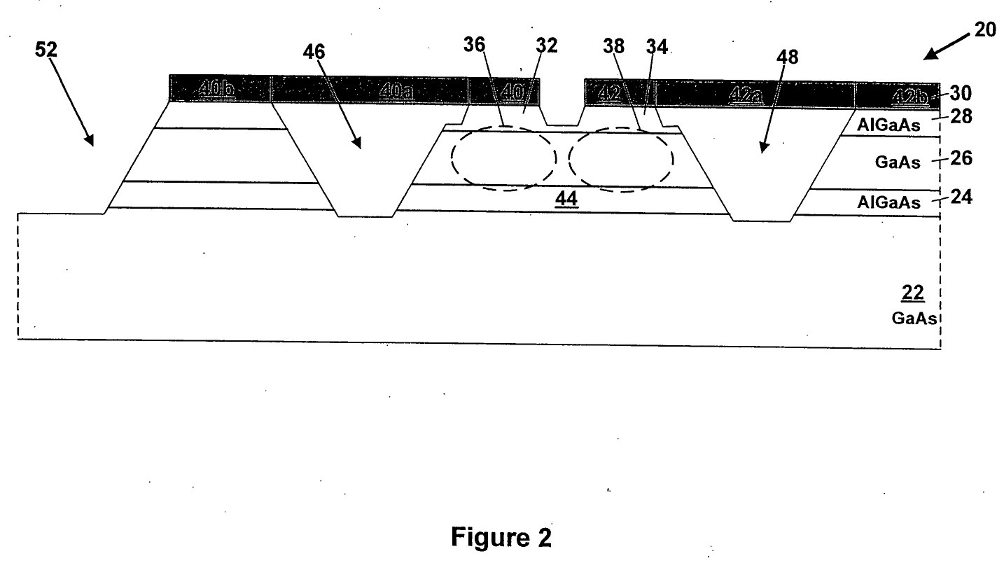

FIGS. 1 and 2 of the present specification are based upon FIGS. 1 and 2 of WO 01/77741 (the entire disclosure of which document is incorporated herein by reference). FIG. 1 is a schematic representation of a known Mach-Zehnder optical modulator in plan view. The modulator comprises an input waveguide 4, an optical splitter 2 which splits light from, the input waveguide 4 into two equal portions of the light which propagate along respective waveguide arms 6 and 8, an optical combiner 10 which recombines the two portions of the light, and two output waveguides 12 and 14 optically coupled to the combiner 10. Each waveguide arm 6, 8 is fabricated from an electro-optic material such that phase shifts may be induced in the light propagating along the waveguide arms by mean of respective electrodes shown adjacent to the waveguide arms. The relative phases of the two portions of the light when they are recombined in the combiner 10 determine the relative intensities of the light emissions from the modulator via the respective output waveguides 12 and 14.

FIG. 2 is a schematic cross-sectional illustration of a known Mach-Zehnder optical modulator fabricated in a GaAs/AlGaAs chip. The cross section is along line A-A of FIG. 1. The optical modulator 20 comprises in order an undoped (semi-insulating) Gallium Arsenide (GaAs) substrate 22, a conductive n-type aluminium gallium arsenide (AlGaAs) layer 24, a further layer of undoped gallium arsenide 26, a further layer of undoped AlGaAs 28 and a metallic conductive layer 30. The GaAs layer 26 provides an optical waveguide medium, with a refractive index contrast between the AlGaAs layers 24 and 28 and the GaAs layer 26 providing vertical confinement thereby constraining light to propagate within the layer 26. The optical waveguide arms (4, 6, of FIG. 1) of the modulator are defined within the GaAs layer 26, and above these, etched into the AlGaAs layer 28 are two respective mesas (plateau regions) 32, 34. The mesas 32, 34, provide an in-plane effective refractive-index contrast that confines the light to two regions beneath the two respective mesas. As shown in FIG. 2, light is confined to two substantially parallel paths, i.e. the waveguide arms, which extend perpendicular to the plane of the paper as illustrated; the light paths (strictly the optical modes) are denoted by broken lines 36 and 38. The metallic layer 30 is appropriately patterned to overlay the mesas 32, 34 and thereby forms respective modulation electrodes 40, 42 of each waveguide arm. The electrodes 40, 42 run the length of the waveguide arms.

Two trenches 46, 48 are etched through the layers 24, 26, 28 and extend parallel to the waveguide arms on each outer side of the arms. The trenches 46, 48 are etched a small distance into the semi-insulating GaAs substrate 22. This provides electrical isolation of the region 44 of the conductive n-doped AlGaAs layer 24 immediately below the waveguides. The reason for this will be explained below.

Electrical connection to the modulator electrodes 40, 42, is made by stranded thin film metal structures 40a, 42a, in the conducting metalisation layer 30, which form air bridges over the isolation trenches 46, 48 to respective modulation drive voltage transmission lines 40b, 42b. In FIG. 2 the left hand modulation drive voltage line 40b comprises an RF modulating drive line and the right hand line 42b an RF modulation drive voltage ground.

As disclosed in WO 01/77741, the Mach-Zehnder modulator illustrated in FIG. 2 of that document (and illustrated in FIG. 2 of the present specification) is operated in what is generally known as a series push-pull drive method. In this method, the electrodes of the two arms of the modulator are electrically connected in series and operated (i.e. “driven”) by a single radio frequency (RF) drive voltage electrical signal. In principle, half of the drive voltage appears across each of the two waveguide arms, in an antiphase relationship. The conductive region 44 forms part of this electrical circuit, such that an electrical field extends from electrode 40, through the waveguide carrying optical mode 36, through the conductive region 44, through the waveguide carrying optical mode 38, and through electrode 42. The electrical field preferably is substantially perpendicular to the plane of the chip (i.e. substantially perpendicular to the planes of the layers of the chip) where it extends through the waveguide layer 26, and preferably it is substantially parallel to the plane of the chip (i.e. substantially in-plane) where it extends through the conductive layer 44. The electrical field extending across the optical modes 36 and 38 results in the light experiencing the electro-optic effect, causing phase modulation which results in the amplitude modulation of the light output of the modulator.

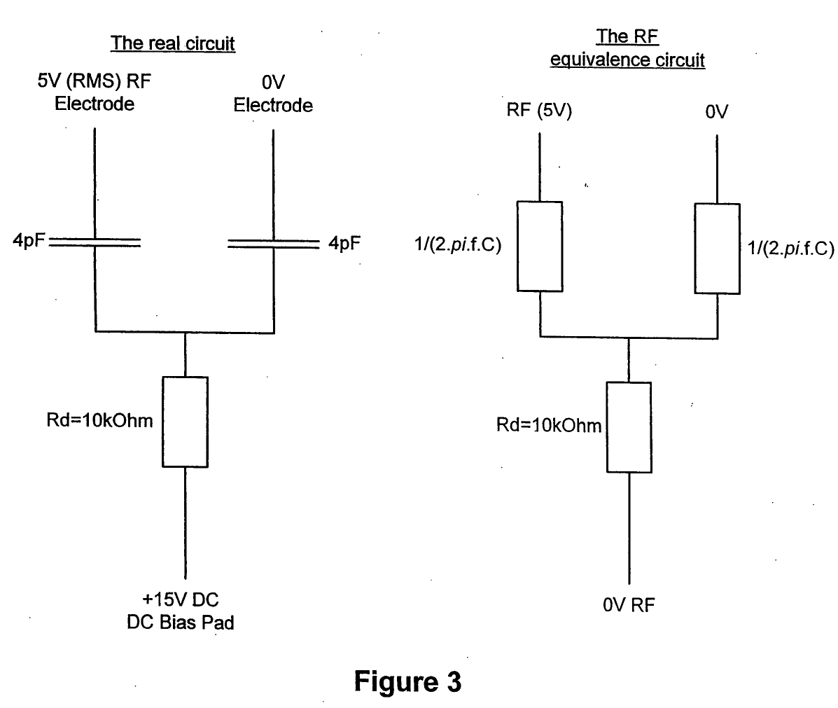

FIG. 3 shows, schematically, the real electrical circuit, and a simplified RF equivalence circuit, for the electrical signals carried by the electrodes 40 and 42 in the series push-pull drive method of the known modulator of FIG. 2. The regions 36 and 38 of the optical modes in the waveguide layer 26 behave as capacitors, and therefore they are shown as such (with capacitances of 4 pF) in the “real circuit” diagram of FIG. 3. (The values of capacitance, electrical potential and resistance are provided in the diagram as examples merely for the purpose of illustration. They are, however, typical example values.) The conductive region 44 of the doped layer 24 beneath the waveguide layer 26 behaves as a resistance, and this is illustrated by means of a resistor of 10 kOhm in FIG. 3. The left hand (as drawn) electrode 40 is shown as a potential of 0-5V RF, and the right hand earth electrode 42 is shown as a potential of 0V. At the bottom of the real circuit is a DC bias pad (at a potential of +15V, as shown) that provides a DC reverse bias across the waveguide layer 26 (between the conductive region 44 and the electrodes 40 and 42). The DC bias is electrically connected to the conductive region 44 of the doped layer 24.

As already mentioned, a simplified RF equivalence circuit for the modulator of FIG. 2 is shown on the right hand side of FIG. 3. At relatively high RF frequencies, for example at 10 MHz or above the impedance between (on one hand) the electrodes 40, 42, and (on the other hand) the conductive region 44 is relatively low (and lower than the RF resistance to RF ground (that is the DC bias pad 72) of the conductive region 44). Consequently the conductive region “floats” at an RF equivalent electrical potential of RF/2, where RF is the applied electrical potential of drive electrode 40. However, the inventors of the present invention have now found that at relatively low RF frequencies (for example less than approximately 4 MHz) the impedance between the electrodes 40, 42 and the conductive region 44 increases and becomes more than the impedance of the conductive region 44 between the waveguide layer 26 and the bias pad (the bias pad acting as an RF ground). Consequently, the RF potential of the conductive region 44 beneath the waveguide layer 26 drops to a value below RF/2, causing the voltage between the drive electrode 40 and the conductive region 44 to be greater than the voltage between the ground electrode 42 and the conductive region 44. Thus, a mismatch or imbalance arises in the electric field across the two waveguide arms (carrying optical modes 36 and 38) of the modulator. Therefore the optical modes propagating in the two waveguide arms experience differing levels of the electro-optic effect. Consequently, the induced phase changes in the two waveguide arms of the modulator are unbalanced (when they should be balanced) and thus the modulator does not function correctly. The imbalance of the applied phase changes in the waveguide arms results in an unwanted residual phase modulation in the output from the modulator. A further effect can be a different amplitude modulation output characteristic from that desired and expected for the modulator.

The present invention seeks (among other things) to solve the above problem.

Accordingly, a first aspect of the present invention provides an optical modulator comprising first and second optical waveguides having first and second electrodes respectively associated therewith, and an electrically conductive region associated with both waveguides, the electrodes having inputs for an electrical signal at input ends thereof, and outputs for the electrical signal at opposite output ends thereof, wherein the conductive region is electrically connected to the output ends of the first and second electrodes such that an electric field created by the electrical signal between the first electrode and the conductive region is substantially equal in magnitude to an electric field created by the electrical signal between the second electrode and the conductive region.

Preferably the electric field created by the electrical signal between the first electrode and the conductive region is opposite in direction to the electric field created by the electrical signal between the second electrode and the conductive region.

The invention has the advantage that the conductive region of the modulator is electrically connected to the output ends of the electrodes such that the voltages between (on the one hand) the first electrode and the conductive region, and (on the other hand) the second electrode and the conductive region are substantially the same as each other (i.e. substantially balanced). Consequently the magnitudes of the electrical fields across the waveguides are substantially balanced. Therefore, the electro-optic effects experienced by optical modes propagating (in use) along the waveguides are substantially balanced, resulting in substantially balanced phase shifts in the waveguides. The above described problem with the modulator disclosed in FIG. 2 of WO 01/77741 (which, as stated above, has been discovered by the inventors of the present invention) is therefore solved by the present invention.

The optical modulator according to the invention preferably is a Mach-Zehnder modulator. The Mach-Zehnder modulator preferably comprises at least one input optical waveguide, optical splitting means optically coupled to the input waveguide, the first and second optical waveguides (which constitute waveguide arms of the modulator) optically coupled to the splitting means, an optical combining means optically coupled to output ends of the optical waveguides, and at least one output optical waveguide optically coupled to the combining means. The optical splitting means and the optical combining means may generally comprise any means for splitting and combining (respectively) the light that propagates through the modulator. For example, the splitting means may comprise an optical splitter, and/or the combining means may comprise an optical combiner. Additionally or alternatively, for example, the splitting means and/or the combining means may comprise a multi-mode interference coupler. Further, the splitting and/or the combining means may comprise a directional coupler (also known as an evanescent optical coupler) or a Y-shaped splitter/coupler.

Preferably the output ends of the electrodes of the modulator (according to all embodiments of the invention) are directly or indirectly connected to an electrical termination for the electrical signal. Advantageously, the electrical termination for the electrical signal is situated off (i.e. away from) the semiconductor chip.

Advantageously, the conductive region may be electrically connected to the output ends of the first and second electrodes at a mid-point of an electrical resistance between them. Alternatively, the conductive region may be electrically connected to the output ends of the first and second electrodes, the connection being to an electrical impedance between them, at a point that is not the mid-point of the impedance.

In some preferred embodiments of the invention, the electrical connection between the conductive region and the output ends of the first and second electrodes is a capacitive connection. In alternative embodiments of the invention, the electrical connection between the conductive region and the output ends of the first and second electrodes is an ohmic (preferably low resistance) connection.

Preferably the modulator according to the invention is fabricated in a semiconductor chip. The semiconductor may generally comprise any semiconductor material, but preferred materials include group III-V semiconductors, and silicon, for example. Particularly preferred are gallium arsenide (GaAs) based semiconductors (and tertiary and quaternary alloys thereof), for example gallium arsenide/aluminium gallium arsenide (GaAs/AlGaAs) semiconductors, and indium phosphide based semiconductors (and tertiary and quaternary alloys thereof). Preferably at least part of the electrical connection between the conductive region and the output ends of the first and second electrodes is fabricated as part of the semiconductor chip, for example by means of a termination electrode of the semiconductor chip.

Preferably the termination electrode of the semiconductor chip comprises a conductive layer, more preferably a metal layer. The termination electrode may, for example, be deposited as a layer on a surface of the semiconductor chip, e.g. by sputtering, thermal evaporation, or chemical vapour deposition. Two alternative techniques are especially suitable for embodiments in which the connection is an ohmic connection: the termination electrode may be deposited and then sintered; or an underlying semiconductor layer may be ion implanted before the termination electrode is deposited. Preferred conductive materials include gold, silver, platinum, copper and aluminium.

The termination electrode preferably is situated in a recess in the semiconductor chip. The recess preferably is formed in the semiconductor material by etching (e.g. by conventional semiconductor etching and fabrication techniques).

For embodiments of the invention in which the electrical connection between the conductive region and the output ends of the first and second electrodes is a substantially capacitive connection, the termination electrode generally is spaced apart from the conductive region. The termination electrode and the conductive region preferably are as close as possible to each other without the termination electrode being in direct physical contact with the conductive region, in order to maximise the electrical contact (and the capacitance) of the electrical connection between them at RF frequencies. A capacitive connection in which the termination electrode does not directly touch the conductive region is generally advantageous because it enables the desired electrical connection to be formed (for example by etching the semiconductor chip to provide a recess for the termination electrode) normally without etching into the conductive region (which would increase the impedance of that portion of the conductive region). Increasing the impedance of the conductive region is generally undesirable because a low impedance contact to the conductive region beneath the waveguides is desired. Alternatively, the recess for the termination electrode can be etched into the conductive region.

The capacitive connection (for those embodiments having a capacitive connection) preferably has a capacitance of at least 200 pF, more preferably at least 400 pF, especially at least 4000 pF, for example approximately 5000 pF, or even higher.

The ohmic connection (for those embodiments having an ohmic connection) preferably has a resistance of no greater than 1000 Ohms, more preferably less than 100 Ohms, and yet more preferably less than 10 Ohms. Where there is such an ohmic connection, a capacitor in series with the termination electrode preferably is included.

As mentioned above, preferably the electrical ground for the electrical signal is situated away from the semiconductor chip. For example, the electrical ground may comprise electrically conductive packaging of a module that contains the modulator, or another conductive component of the module. The conductive packaging preferably is formed substantially from metal (e.g. Kovar—an iron alloy) or a conductive polymer.

Advantageously, the electrical connection between the termination electrode and the output ends of the first and second electrodes may be situated away from the semiconductor chip. Additionally, at least part of the electrical impedance between the output ends of the first and second electrodes may be situated away from the semiconductor chip. For example, the electrical connection and/or at least part of the electrical impedance, may be situated on a separate substrate away from the semiconductor chip. The separate substrate may comprise a tile (or similar), for example formed from silica, on which “off-chip” electronics of the modulator are mounted.

In preferred embodiments of the invention, at least part of the first electrode is situated on the first optical waveguide, and at least part of the second electrode is situated on the second optical waveguide.

The first and second electrodes preferably comprise travelling wave electrodes. The electrodes preferably include transmission lines for the electrical signal, the transmission line of each electrode preferably being situated adjacent to its associated optical waveguide. Advantageously each electrode may comprise a plurality of segments, preferably situated on their respective associated optical waveguides. Preferably, in use, the phase velocity of the travelling electrical signal is substantially matched to the group velocity of the optical mode propagating along the waveguides, in order to maximise the optical phase modulation caused by the electrodes.

Advantageously, two modulators (or more than two, but preferably only two) as described above, may be monolithically integrated on the same semiconductor chip, and each modulator may have a respective electrical termination arrangement as also described above.

Accordingly, a second aspect of the invention provides a semiconductor chip including two optical modulators according to the first aspect of the invention integrated thereon.

Preferably the two modulators are arranged such that their optical outputs are combined. Advantageously, the modulators may be arranged to provide optical phase shift key (optical PSK) modulation of an optical signal. Preferably, the optical PSK is optical differential phase shift key (optical DPSK). Advantageously, the PSK may be quaternary PSK (QPSK), but other M-ary PSK is also possible. Particularly preferred methods, systems and arrangements with which the present invention may be used are disclosed in international patent application WO 02/51041, the entire disclosure of which is incorporated herein by reference.

According to a third aspect, the invention provides an opto-electronics module, for example a telecommunications optical transmitter, that contains one or more modulators according to the first aspect of the invention, or one or more semiconductor chips according to the second aspect of the invention.

Preferred embodiments of the invention will now be described, by way of example, with reference to the accompanying drawings, of which:

FIG. 1 is a schematic representation of a known Mach-Zehnder optical modulator in plan view;

FIG. 2 is a schematic cross-sectional illustration of a known Mach-Zehnder optical modulator fabricated in a GaAs/AlGaAs semiconductor chip;

FIG. 3 shows, schematically, the real electrical circuit, and a simplified RF equivalence circuit, for a series push-pull drive method of the known modulator of FIG. 2;

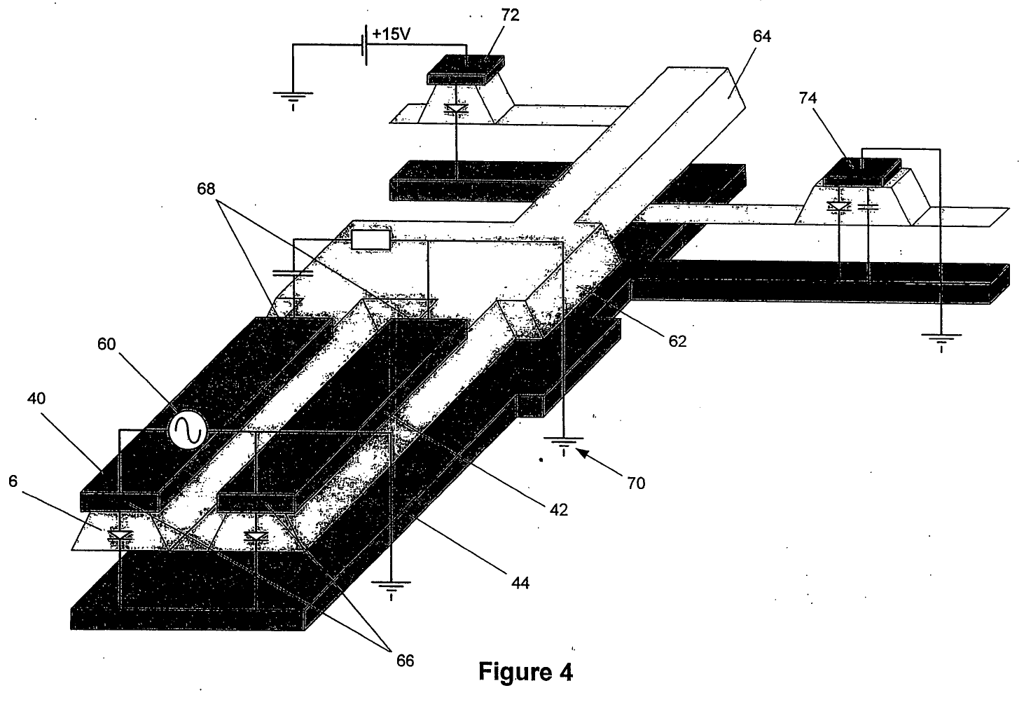

FIG. 4 is a schematic illustration of part of the known Mach-Zehnder optical modulator of FIG. 2;

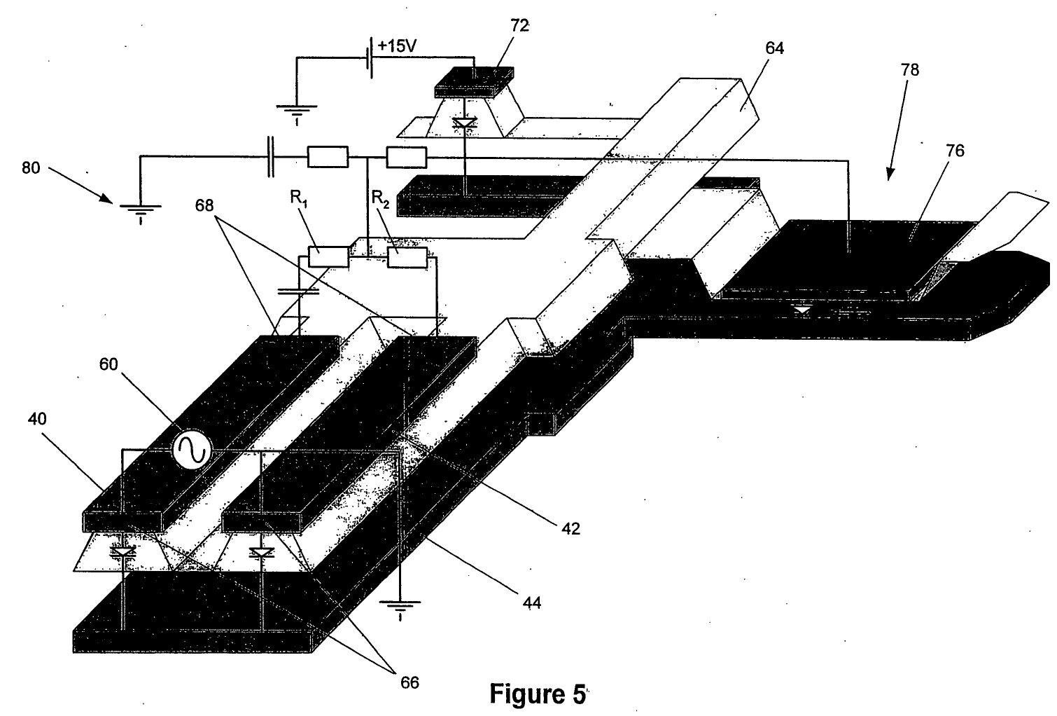

FIG. 5 is a schematic illustration of part of a preferred embodiment of a Mach-Zehnder optical modulator according to the invention;

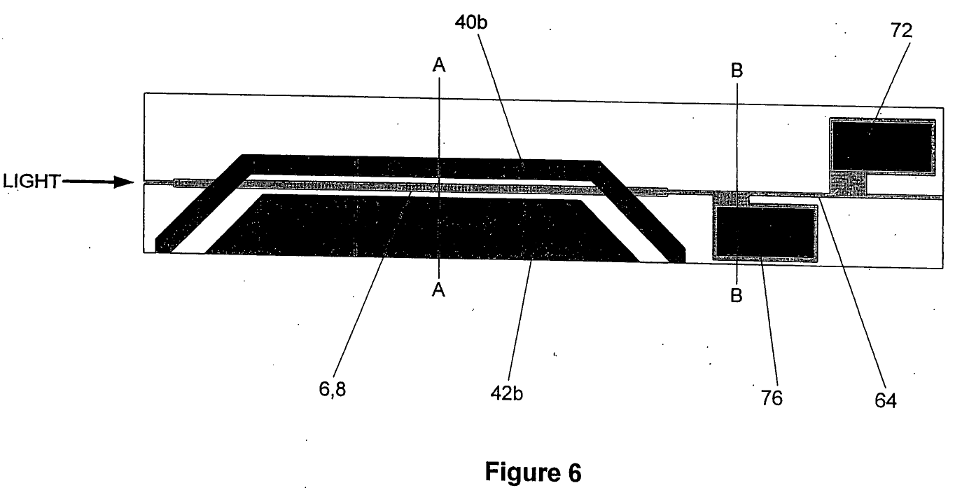

FIG. 6 is a plan view schematic illustration of another preferred embodiment of a Mach-Zehnder optical modulator according to the invention;

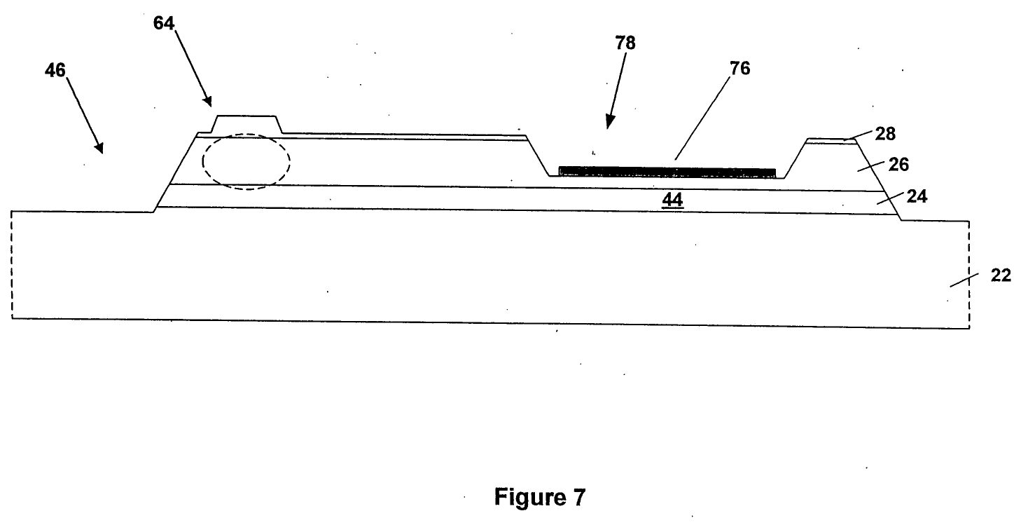

FIG. 7 is a schematic cross-sectional illustration of the Mach-Zehnder optical modulator of FIG. 6.

FIGS. 1 to 3 are described in detail earlier in this specification.

FIG. 4 is a schematic illustration of the known Mach-Zehnder optical modulator of FIG. 2. The modulator comprises first and second waveguides 6 and 8 with respective associated first and second electrodes 40 and 42, electrode 40 being a drive electrode and electrode 42 being a ground electrode. A radio frequency electrical drive signal is applied to the electrodes by an RF drive indicated by reference numeral 60. The electrodes 40 and 42 are shown schematically merely as strips lying on top of their respective waveguides 6 and 8, but preferably the electrodes are travelling wave electrodes, each of which comprises a transmission line extending adjacent to its associated waveguide, and having electrode segments extending therefrom periodically along the electrode, the segments lying on top of the associated waveguide. Such an arrangement is as described in WO 01/77741. Beneath the waveguides (as drawn) is a conductive region that is associated with both of the waveguides (i.e. it extends continuously beneath both waveguides).

The first and second waveguides 6 and 8 are optically coupled at output ends of the waveguides by an optical coupling means 62, and an output waveguide 64 extends from the coupling means 62. For simplicity and clarity, no input waveguide or input coupling means are shown, but would be present.

The electrical drive signal is applied across the electrodes 40 and 42 at input ends 66 of the electrodes, such that an electrical field extends from drive electrode 40 through the first waveguide 6, through the conductive region 44, through the second waveguide 8 to the ground electrode 42 (which may be earthed along its length). Output ends 68 of the electrodes (at the opposite end of each electrode to its input end) are connected together by an electrical termination, which may also be connected to an electrical ground 70 for the radio frequency electrical signal. A DC bias pad 72 provides a DC potential bias between the conductive region 44 and the electrodes 40, 42 and 74. Also shown is a decoupling capacitor 74, which is the “dc-coupling (sic) capacitor C_{d} 50” referred to in WO 01/77741 with reference to FIG. 3 of that document. The upper metal layer of the decoupling capacitor 74 is level with the top surfaces of the waveguides. It is to be noted that the decoupling capacitor 74 is not connected to the electrodes 40, 42. Such capacitors have a low capacitance of 110 or 150 pF.

FIG. 5 is a schematic illustration of a preferred embodiment of a Mach-Zehnder optical modulator according to the invention. FIG. 5 has a similar format to that of FIG. 4, in order to highlight the differences between this embodiment of the invention, and the known modulator of FIG. 4. Consequently, like features have the same reference numerals in FIGS. 4 and 5.

The main differences between the known modulator shown in FIG. 4, and the modulator according to the invention shown in FIG. 5, are the presence of a termination electrode 76 and electrical connections concerning this termination electrode, in the FIG. 5 modulator (and the absence of a decoupling capacitor connected directly to ground). The termination electrode 76 preferably is a metallic layer or layers, and typically the top layer is a layer of gold. The termination electrode has been deposited on the semiconductor chip in a recess 78 etched into the semiconductor material of the chip, such that the termination electrode 76 may be spaced apart from the conductive region 44, and forms a capacitive connection with the conductive region 44. As shown schematically, the termination electrode 76 is electrically connected to the output ends 68 of the first and second electrodes 40, 42. Consequently, the conductive region 44 is electrically connected to the output ends 68 of the first and second electrodes 40,42 by a capacitive connection (by means of the termination electrode 76). The connection to the output ends 68 of the first and second electrodes 40,42 may be at a mid-point of an electrical resistance R (where R=R₁+R₂) between the output ends of the first and second electrodes. Alternatively, the conductive region 44 may be electrically connected to the output ends 68 of the first and second electrodes, in an electrical impedance between them, at a point that is not the mid-point of the impedance. The output ends 68 of the first and second electrodes are also connected to an electrical ground 80 for the radio frequency electrical signal.

Preferably the electrical connection between the termination electrode 76 and the output ends of the first and second electrodes is situated off the semiconductor chip, preferably on another substrate (not shown). The other substrate preferably is a tile (or the like) that accommodates off-chip termination electronics for the electrical signal. At least parts of the electrical resistances R₁ and R₂ are also situated on the other substrate (minor parts of the resistances R₁ and R₂ may be constituted by electrical conductors extending from the semiconductor chip to the other substrate). The electrical ground 80 for the RF electrical signal may be situated on the other substrate, or may comprise another part of the modulator, for example electrically conductive packaging of the modulator.

FIG. 6 is a schematic plan view of another preferred embodiment of a Mach-Zehnder optical modulator according to the invention. This embodiment is similar to that shown in FIG. 5, and has a cross-section along line A-A corresponding to the cross-section illustrated in FIG. 2. The relatively large transmission lines 40b and 42b are shown, whereas the relatively smaller electrodes 40 and 42 extending from the transmission lines are not shown. The first and second waveguides 6 and 8 are indicated as a single relatively wide strip, and the single output waveguide 64 is shown extending from the first and second waveguides. Also shown are the termination electrode 76, and the DC bias pad 72.

FIG. 7 is a schematic cross-sectional view along line B-B of FIG. 6. This view shows the etched recess 78 in the semiconductor chip, in which the termination electrode 76 is deposited. The recess is typically etched through the AlGaAs layer 28, and part way through the GaAs waveguide layer 26, such that there is a portion of the GaAs waveguide layer 26 situated between the termination electrode 76 and the conductive region 44. Alternatively, the recess may be etched through the GaAs waveguide layer 26, or even etched into the conductive region 44. The surface area of the major surface of the termination electrode 76 preferably is of the order of 1 mm² to 10 mm², for example approximately 3 mm². Also shown in FIG. 7 is the output waveguide 64, neighbouring the recessed region 78 containing the termination electrode 76.

1. An optical modulator, comprising first and second optical waveguides having first and second electrodes respectively associated therewith, and an electrically conductive region associated with said first and second waveguides, the electrodes having inputs for an electrical signal at input ends thereof, and outputs for the electrical signal at opposite output ends thereof, wherein the conductive region is electrically connected to the output ends of the first and second electrodes such that an electric field created by the electrical signal between the first electrode and the conductive region is substantially equal in magnitude to an electric field created by the electrical signal between the second electrode and the conductive region.

2. A modulator according to claim 1, wherein the electric field created by the electrical signal between the first electrode and the conductive region is opposite in direction to the electric field created by the electrical signal between the second electrode and the conductive region.

3. A modulator according to claim 1, fabricated in a semiconductor chip.

4. A modulator according to claim 1, wherein the output ends of the electrodes are connected to an electrical ground for the electrical signal.

5. A modulator according to claim 1, wherein the conductive region is electrically connected to the output ends of the first and second electrodes, the connection being to an electrical impedance between the output ends of the first and second electrodes.

6. A modulator according to claim 5, wherein the conductive region is electrically connected to the output ends of the first and second electrodes at a mid-point of an electrical resistance between the output ends of the first and second electrodes.

7. A modulator according to claim 1, wherein the electrical connection between the conductive region and the output ends of the first and second electrodes comprises a capacitive connection.

8. A modulator according to claim 1, wherein the electrical connection between the conductive region and the output ends of the first and second electrodes is an ohmic connection.

9. A modulator according to claim 3, wherein at least part of the electrical connection has been fabricated as part of the semiconductor chip.

10. A modulator according to claim 9, wherein the electrical connection comprises a termination electrode of the semiconductor chip.

11. A modulator according to claim 10, wherein the termination electrode comprises a metal layer.

12. A modulator according to claim 10, wherein the termination electrode is situated in a recess in the semiconductor chip.

13. A modulator according to claim 10, wherein the termination electrode is spaced apart from the conductive region.

14. A modulator according to claim 7, wherein the capacitive connection has a capacitance of at least 200 pF.

15. A modulator according to claim 14, wherein the capacitive connection has a capacitance of at least 400 pF.

16. A modulator according to claim 8, wherein the ohmic connection has a resistance of no greater than 1000 Ohms.

17. A modulator according to claim 16, wherein the electrical ground for the electrical signal comprises conductive packaging of a module containing the modulator, or another conductive component of the module, or is external to the module.

18. A modulator according to claim 10, wherein the electrical connection between the termination electrode and the output ends of the first and second electrodes is situated away from the semiconductor chip.

19. A modulator according to claim 5, wherein the modulator is fabricated in a semiconductor chip, and wherein at least part of the electrical impedance between the output ends of the first and second electrodes is situated away from the semiconductor chip.

20. A modulator according to claim 1, wherein at least part of the first electrode is situated on the first optical waveguide, and at least part of the second electrode is situated on the second optical waveguide.

21. A modulator according to claim 1, wherein the first and second electrodes comprise travelling wave electrodes.

22. A modulator according to claim 1, wherein the first and second electrodes include transmission lines for the electrical signal, the transmission line of each electrode being situated adjacent to an associated optical waveguide.

23. A modulator according to claim 1, wherein the first and second electrodes each comprise a plurality of segments, situated on a respective associated optical waveguide.

24. A modulator according to claim 1, comprising a Mach-Zehnder modulator.

25. A modulator according to claim 24, further comprising at least one input waveguide, optical splitting means optically coupled to the input waveguide, the first and second optical waveguides optically coupled to the splitting means, an optical combining means optically coupled to output ends of the optical waveguides, and at least one output optical waveguide optically coupled to the combining means.

26. A semiconductor chip comprising two optical modulators according to claim 1 integrated thereon.

27. A semiconductor chip according to claim 26, wherein optical outputs of the modulators are combined.

28. A modulator or semiconductor chip according to claim 1, arranged to provide optical phase shift key modulation of an optical signal.

29. A modulator or semiconductor chip according to claim 28, arranged to provide optical differential phase shift key modulation of an optical signal.

30. An opto-electronics modules, comprising one or more modulators or semiconductor chips according to claim 1.

31. An opto-electronics module according to claim 30, comprising a telecommunications optical transmitter.
